(19) United States
(12) Patent Application Publication
(10) Pub. No.: US 2010/0254434 A1
(43) Pub. Date: Oct. 7, 2010

(54) RADIO COMMUNICATION DEVICE AND SEQUENCE CONTROL METHOD

(75) Inventors: Takashi Iwai, Ishikawa (JP); Daichi Imamura, Kanagawa (JP); Seigo Nakao, Kanagawa (JP); Tomofumi Takata, Ishikawa (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/740,109

(22) PCT Filed: Oct. 29, 2008
(86) PCT No.: PCT/JP2008/003097

§ 371 Date: Apr. 27, 2010

(30) Foreign Application Priority Data
Oct. 30, 2007 (JP) 2007-282450

(51) Int. Cl. H04B 1/707

(52) U.S. Cl. 375/141; 375/E01.003

(57) ABSTRACT

Provided is a radio communication device which can reduce the affect of inter-cell interference using a small reception process amount. The radio communication device includes a sequence number setting unit (101) which sets a sequence number for a ZAC sequence used for spreading a response signal and another sequence number for a ZAC sequence used for a reference signal in a ZAC sequence generation unit (102) and a ZAC sequence generation unit (109), respectively. The ZAC sequence generation unit (102) generates a ZAC sequence of the set sequence number from the sequence number setting unit (101). A spread unit (104) spreads the response signal. The ZAC sequence generation unit (109) generates a set ZAC sequence from the sequence number setting unit (101) and outputs the ZAC sequence as a reference signal to an IF FT unit (110). A sequence number setting unit (101) changes the sequence number at a transmission switching timing between the response signal and the reference signal.

### TECHNICAL FIELD

The present invention relates to a radio communication apparatus and a sequence control method.

### BACKGROUND ART

In mobile communication, ARQ (Automatic Repeat reQuest) is applied to downlink data from a radio communication base station apparatus (hereinafter referred to as a “base station”) to a radio communication mobile station apparatus (hereinafter referred to as a “mobile station”). That is, the mobile station feeds a response signal indicating an error detection result of downlink data back to the base station. The mobile station performs CRC (Cyclic Redundancy Check) of downlink data, and when the detection result is “CRC=OK” (no error), the mobile station feeds ACK (Acknowledgment) back to the base station as a response signal, and when the detection result is “CRC=NG” (error present), the mobile station feeds NACK (Negative Acknowledgment) back to the base station as a response signal. This response signal is transmitted to the base station using an uplink control channel such as a PUCCH (Physical Uplink Control Channel).

In addition, as shown in FIG. 1, code multiplexing, allowed by spreading a plurality of response signals from a plurality of mobile stations using ZAC (Zero Auto Correlation) sequences and Walsh sequences, is under study (see Non-Patent Document 1). In FIG. 1, [W₀, W₁, W₂, W₃] shows Walsh sequences of a sequence length of 4. As shown in FIG. 1, in the mobile station first, a response signal, ACK or NACK, is primarily spread in the frequency domain by sequences having the time domain characteristic of ZAC sequences (sequence length of 12). Next, an IFFT (Inverse Fast Fourier Transform) is performed on the response signals after the primary spreading, in association with each of [W₀, W₁, W₂, W₃]. The response signals spread in the frequency domain are transformed to time domain ZAC sequences of a sequence length of 12 by this IF FT. Then, the signals after the IFFT are further secondarily spread using Walsh sequences (sequence length of 4). That is, one response signal is arranged in each of four SC-FDMA (Single Carrier-Frequency Division Multiple Access) symbols D₀ to D₃. In the same way, response signals are spread using ZAC sequences and Walsh sequences in other mobile stations. Here, ZAC sequences having different amounts of time domain cyclic shift each other, or Walsh sequences differing each other, are used between different mobile stations. Here, since the sequence length of the time domain ZAC sequence is 12, twelve ZAC sequences generated from one ZAC sequence, which have the amounts of cyclic shift from 0 to 11, can be_used. In addition, since the sequence length of Walsh sequence is 4, four Walsh sequences differing each other can be used. Therefore, in an ideal communication environment, it is possible to code-multiplex response signals from maximum 48 (12×4) mobile stations.

Moreover, as shown in FIG. 1, study is under way to code-multiplex a plurality of reference signals (RS) from a plurality of mobile stations (see Non-Patent Document 1). As shown in FIG. 1, when a reference signal having three symbols R₀, R₁, and R₂ is generated from ZAC sequences (sequence length of 12), first, an IFFT is applied to the ZAC sequences corresponding to orthogonal sequences [F₀, F₁, F₂] of a sequence length of 3, such as Fourier sequences, respectively. The time domain ZAC sequence having a sequence length of 12 can be acquired by this IFFT. Then, the signal after the IFFT is spread using orthogonal sequences [F₀, F₁, F₂]. That is, one reference signal (ZAC sequence) is arranged in each of three symbols R₀, R₁ and R₂. In the same way, one reference signal (ZAC sequence) is arranged in each of three symbols R₀, R₁ and R₂. In other mobile stations. Here, time domain ZAC sequences having different amounts of cyclic shift each other, or Walsh sequences differing each other are used between different mobile stations. Here, since the sequence length of the time domain ZAC sequence is 12, twelve ZAC sequences generated from one ZAC sequence, which have the amounts of cyclic shift from 0 to 11, can be_used. In addition, since the sequence length of the orthogonal sequence is 3, three orthogonal sequences differing each other can be used. Therefore, in an ideal communication environment, it is possible to code-multiplex maximum 36 (12×3) reference signals from the mobile station.

Then, as shown in FIG. 1, one slot is composed of seven SC-FDMA symbols D₀, D₁, R₀, R₁, R₂, D₂ and D₃. Here, one SC-FDMA symbol shown in FIG. 1 may be referred to as one “LB (Long Block)”. In addition, each symbol may be called by its LB number, and symbols are referred to as LB numbers 1, 2, 3, . . . , 7, in order from the first symbol (D₀) in each slot.

Here, among ZAC sequences, there are combinations of sequences having larger cross correlation. When a plurality of ZAC sequences having larger cross correlation are allocated to a plurality of neighboring cells, respectively, inter-cell interference by a PUCCH increases between mobile stations in those cells, and therefore demodulation performance of response signals deteriorates.

In order to reduce the influence of this inter-cell interference, study is underway to use a technology referred to as “sequence hopping” that changes sequence numbers of ZAC sequences used as a reference signal at predetermined time intervals (see Non-Patent Document 2 and Non-Patent Document 3). This technology allows randomizing (uniforming or equalizing) the influence of inter-cell interference on mobile stations. Therefore, by using this technology, it is possible to prevent deterioration of demodulation performance caused by durably subjecting only a certain mobile station to large inter-cell interference.

In addition, study is under way to execute sequence hopping at slot intervals (see Non-Patent Document 2). For example, when sequence hopping is applied to the PUCCH in FIG. 1, the sequence numbers of ZAC sequences are set as shown in FIG. 2. s1 to s3 in FIG. 2 show the sequence numbers of ZAC sequences used for respective symbols. Therefore, sequence hopping to change the sequence numbers per slot time is shown in FIG. 2.

Moreover, study is underway to execute sequence hopping at symbol intervals (see Non-Patent Document 3). For example, when sequence hopping is applied to the PUCCH in FIG. 1, the sequence numbers of ZAC sequences are set as shown in FIG. 3. s1 to s15 in FIG. 3 show the sequence numbers of ZAC sequences used for respective symbols. Therefore, sequence hopping to change the sequence number per symbol time is shown in FIG. 2.

Since the sequence number of ZAC sequence used for each cell is changed over time by this sequence hopping, the influence of inter-cell interference can be randomized, so that it is possible to prevent only a certain mobile station from being durably subjected to large inter-cell interference.

Non-Patent Document 1: Nokia Siemens Networks, Nokia, R1-072315, “Multiplexing capability of CQIs and ACK/NACKs form different UEs”, 3GPP TSG RAN WG1 Meeting #49, Kobe, Japan, May 7-11, 2007

Non-Patent Document 2: Huawei, RI-071109, “Sequence Allocation Method for E-UTRA Uplink Reference Signal”, 3GPP TSG RAN WG1 Meeting #48, St. Louis, USA, Feb. 12-16, 2007

Non-Patent Document 3: NTT DoCoMo, R1-074278, “Hopping and Planning of Sequence Groups for Uplink RS”, 3GPP TSG RAN WG1 Meeting #50 bis, Shanghai, China, Oct. 8-12, 2007

### DISCLOSURE OF INVENTION

### Problems to be Solved by the Invention

With the above-described conventional sequence hopping at slot intervals, the randomizing effect of inter-cell interference is low. With asynchronous base stations, this sequence hopping may cause using the same sequence number between cells (hereinafter referred to as “collision”). In this case, when the above-described conventional sequence hopping at slot intervals is employed, all the ZAC sequences of the response signal and the reference signal in a slot (i.e., 7 symbols D₀, D₁, R₀, R₂, D₂ and D₃) collide, and therefore the demodulation performance deteriorates.

In addition, the above-described conventional sequence hopping at symbol intervals has a problem that the amount of processing (amount of computation) required to demodulate response signals increases as compared with sequence hopping at slot intervals.

FIG. 4 shows reception processing for sequence hopping at slot intervals and FIG. 5 shows reception processing for sequence hopping at symbol intervals. As shown in FIG. 4 and FIG. 5, the receiving side corrects the received time domain PUCCH signal to the ZAC sequence before cyclic shifting on the transmitting side by performing the cyclic shifting of the PUCCH signal through the same amount as on the transmitting side in the opposite direction. Next, the response signal is multiplied by the complex conjugate of the Walsh sequence multiplied on the transmission side, and the reference signal is multiplied by the complex conjugate of the Fourier sequence multiplied on the transmitting side. Next, the time domain PUCCH signal is transformed into a frequency domain PUCCH signal by performing an FFT (Fast Fourier Transform). Next, correlation computation (complex division) with the ZAC sequence is applied to the frequency domain PUCCH signal. Then, with the reference signal, a channel estimation value is derived by performing in-phase addition of the correlation computation result calculated from three symbols R₀, R₁ and R₂. Meanwhile, with the response signal, by performing in-phase addition of the correlation computation result calculated from four symbols D₀ to D₃, phase correction and amplitude correction are performed using the channel estimation value.

When FIG. 4 and FIG. 5 are compared, it can be observed that the amounts of the FFT and ZAC sequence correlation computation processing are large with the sequence hopping at symbol intervals shown in FIG. 5. With the sequence hopping at slot intervals shown in FIG. 4, the FFT and ZAC sequence correlation computation processing are performed twice per slot, while with the sequence hopping at symbol intervals shown in FIG. 5, the FFT and ZAC sequence correlation computation processing must be performed seven times per slot. The reason for this is that, with sequence hopping at symbol intervals, the ZAC sequence to use as the response signal or as the reference signal is different per symbol (per LB), and therefore, unlike sequence hopping at slot intervals, it is not possible to perform the FFT and ZAC sequence correlation computation processing all together by performing in-phase addition on the time domain PUCCH before the FFT.

It is therefore an object of the present invention to provide a radio communication apparatus and a sequence control method that can reduce the influence of inter-cell interference while maintaining the same amount of reception processing (amount of computation) as compared with sequence hopping at slot intervals.

### Means for Solving the Problem

The radio communication apparatus according to the present embodiment has a configuration including: a spreading section that spreads a response signal using a first sequence; a generating section that generates a reference signal for demodulating the response signal using a second sequence; and a sequence setting section that switches between the first sequence and the second sequence at a timing to switch between transmission of the response signal and transmission of the reference signal.

The sequence control method according to the present invention includes the steps of: spreading a response signal using a first sequence; generating a reference signal for demodulating the response signal using a second sequence; and switching between the first sequence and the second sequence at a timing to switch between transmission of the response signal and transmission of the reference signal.

### Advantageous Effects of Invention

According to the present invention, it is possible to reduce influence of inter-cell interference while maintaining the same amount of reception processing (amount of computation) as compared with sequence hopping at slot intervals.

### BRIEF DESCRIPTION OF DRAWINGS

FIG. 1 is a drawing showing a spreading method of a response signal and a reference signal (prior art);

FIG. 2 is a drawing showing sequence hopping at slot intervals (prior art);

FIG. 3 is a drawing showing sequence hopping at symbol intervals (prior art);

FIG. 4 is a drawing showing reception processing for the sequence hopping at slot intervals (prior art);

FIG. 5 is a drawing showing reception processing for sequence hopping at symbol intervals (prior art);

FIG. 6 is a block diagram showing a configuration of a mobile station according to an embodiment of the present invention;

FIG. 7 is a block diagram showing a configuration of a base station according to an embodiment of the present invention;

FIG. 8 is a drawing showing a method for setting sequence numbers according to an embodiment of the present invention (example 1);

FIG. 9 is a drawing showing a method for setting sequence numbers according to an embodiment of the present invention (example 2);

FIG. 10 is a drawing showing in-phase addition processing according to an embodiment of the present invention (example 1);

FIG. 11 is a drawing showing in-phase addition processing according to an embodiment of the present invention (example 2);

FIG. 12 is a drawing showing a method for setting sequence numbers according to an embodiment of the present invention (example 3);

FIG. 13 is a drawing showing a method for setting sequence numbers according to an embodiment of the present invention (example 4); and

FIG. 14 is a drawing showing a method for setting sequence numbers according to an embodiment of the present invention (example 5).

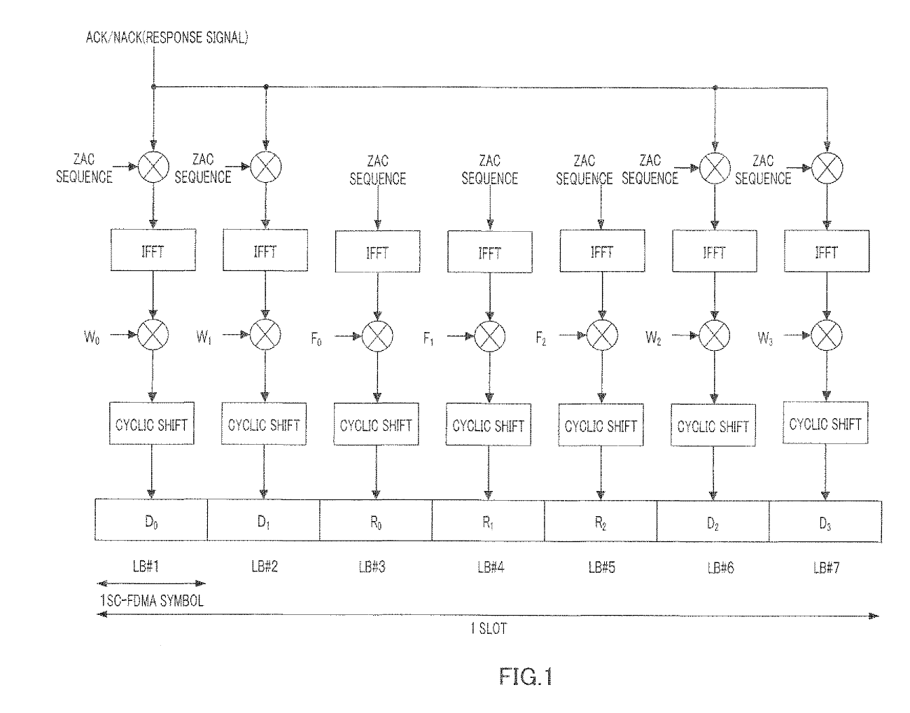

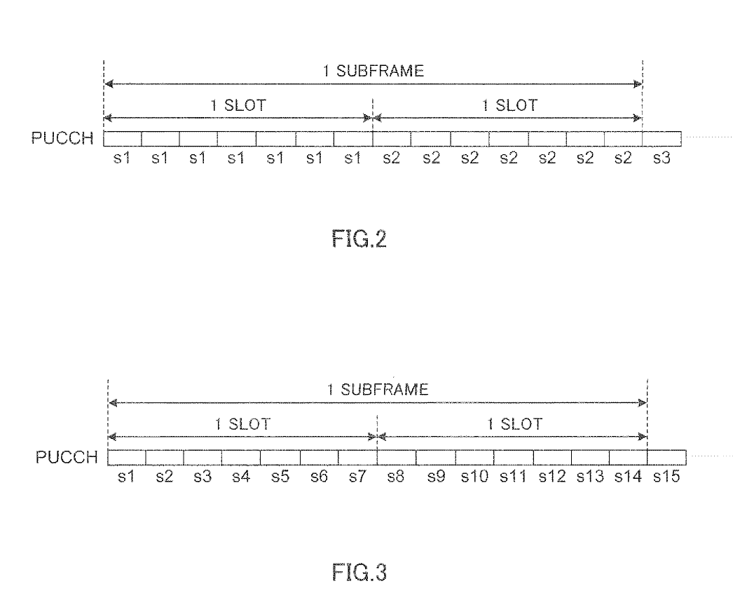

### BEST MODE FOR CARRYING OUT THE INVENTION

Now, embodiments of the present invention will be described in detail with reference to the accompanying drawings.

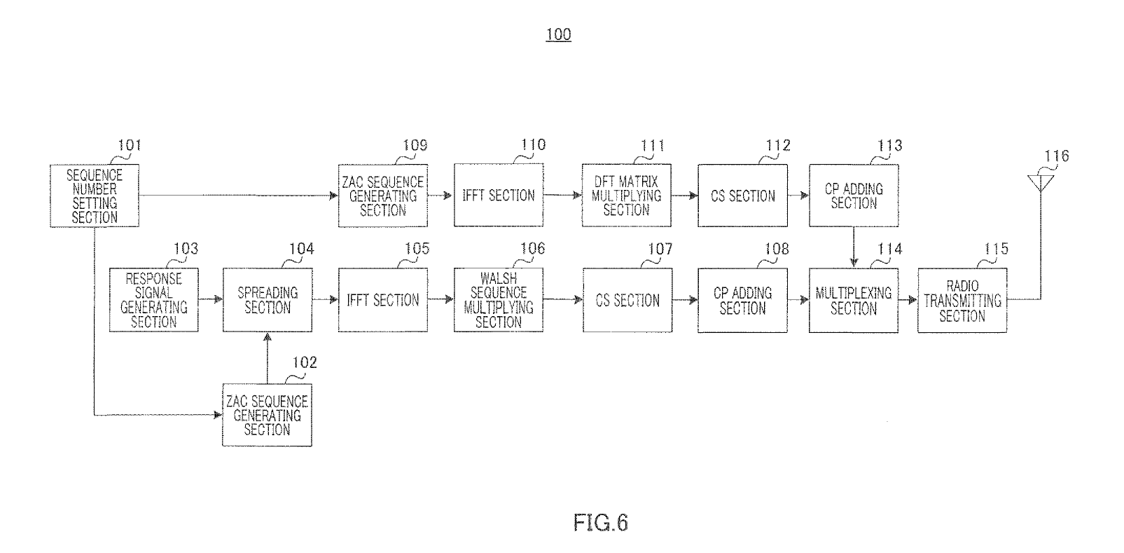

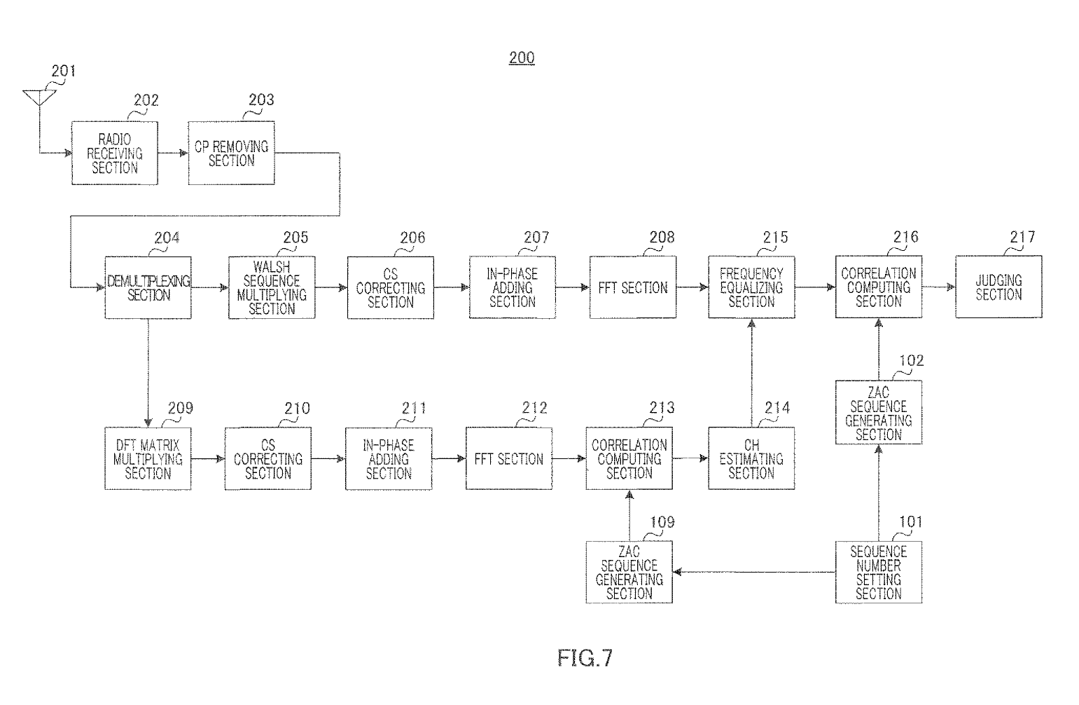

FIG. 6 shows a configuration of mobile station 100 according to the present embodiment, and FIG. 7 shows a configuration of base station 200 according to the present embodiment.

Now, a case will be described where ZAC sequences are used for primary spreading and Walsh sequences or DFT (Discrete Fourier Transform) sequences are used for secondary spreading. However, sequences other than ZAC sequences, which can be separated from each other by different amounts of cyclic shift may be used for primary spreading. For example, GCL (Generalized Chirp like) sequences, CAZAC (Constant Amplitude Zero Auto Correlation) sequences, ZC (Zadoff-Chu) sequences, or PN sequences such as M sequences and orthogonal Gold code sequences and so forth may be used for primary spreading. Meanwhile, for secondary spreading, any sequences may be used as secondary spreading code sequences, including sequences orthogonal to each other, or sequences which can be viewed as to be approximately orthogonal to each other.

Mobile station 100 shown in FIG. 6 transmits a response signal, and a reference signal used to demodulate the response signal.

In mobile station 100, sequence number setting section 101 calculates the ZAC sequence to use to spread the response signal and the sequence number of the ZAC sequence used for the reference signal in accordance with a predetermined rule, sets the sequence number of the ZAC sequence to use to spread the response signal in ZAC sequence generating section 102 and sets the sequence number of the ZAC sequence used for the reference signal in ZAC sequence generating section 109. The method of setting sequence numbers will be described in detail later.

ZAC sequence generating section 102 generates the ZAC sequence having the sequence number set by sequence number setting section 101 and outputs the ZAC sequence to spreading section 104.

Response signal generating section 103 performs CRC (Cyclic Redundancy Check) of downlink data, generates ACK (Acknowledgment) as a response signal when the result is CRC=OK (no error), generates NACK (Negative Acknowledgment) as a response signal when the result is CRC=NG (error present), and outputs the response signal to spreading section 104.

Spreading section 104 performs primary spreading of the response signal inputted from response signal generating section 103 with the ZAC sequence inputted from ZAC sequence generating section 102, and outputs the response signal after primary spreading to IFFT section 105.

IFFT section 105 performs an IFFT of the response signal after the primary spreading and outputs the response signal after the IFFT to Walsh sequence multiplying section 106.

Walsh sequence multiplying section 106 multiplies the response signal after the IFFT by a Walsh sequence and outputs the result to CS section 107. That is, Walsh sequence multiplying section 106 performs secondary spreading of the response signal after the IFFT using the Walsh sequence.

CS section 107 performs cyclic shift (CS) of the response signal after the Walsh sequence multiplication through a predetermined length of time and outputs the result to CP adding section 108.

CP adding section 108 adds the same signal as the rear end of the response signal after CS to the beginning of that response signal as a CP.

ZAC sequence generating section 109 generates the ZAC sequence of the sequence number set by sequence number setting section 101 and outputs the ZAC sequence as a reference signal to IFFT section 110.

IFFT section 110 performs an IFFT of the reference signal inputted from ZAC sequence generating section 109 and outputs the response signal after the 1FFT to DFT matrix multiplying section 111.

DFT matrix multiplying section 111 multiplies the reference signal after the IFFT by a DFT sequence and outputs the result to CS section 112. That is, DFT matrix multiplying section 111 performs secondary spreading of the reference signal after the IFFT using the DFT sequence.

CS section 112 performs cyclic shift of the reference signal after multiplication by the DFT sequence through a predetermined length of time and outputs the result to CP adding section 113.

CP adding section 113 adds the same signal as the rear end of the reference signal after cyclic shift to the beginning of that response signal as a CP and outputs the result to multiplexing section 114.

Multiplexing section 114 time-multiplexes the response signal with a CP and the reference signal with a CP in one slot and outputs the result to radio transmitting section 115.

Radio transmitting section 115 performs transmission processing, including D/A conversion, amplification, up-conversion and so forth, of the response signal or reference signal inputted from multiplexing section 114 and transmits the processed signal from antenna 116 to base station 200 (FIG. 6).

Here, the same effect as this can be obtained by providing CS section 112 and CS section 107 before IFFT section 110 and IFFT section 105 and performing phase rotation processing in the frequency domain.

On the other hand, base station 200 shown in FIG. 7 receives and demodulates the response signal and the reference signal transmitted from mobile station 100.

In base station 200, radio receiving section 202 receives the response signal and the reference signal transmitted from mobile station 100 via antenna 201 and performs reception processing, including down-conversion, A/D conversion and so forth, of the received signals.

CP removing section 203 removes the CPs added to the response signal and the reference signal after reception processing.

Demultiplexing section 204 time-demultiplexer the response signal and the reference signal from which the CPs have been removed in one slot, outputs the response signal to Walsh sequence multiplying section 205 and outputs the reference signal to DFT matrix multiplying section 209.

Walsh sequence multiplying section 205 multiplies the response signal by the complex conjugate of the Walsh sequence multiplied in Walsh sequence multiplying section 106, and outputs the result to CS correcting section 206.

CS correcting section 206 performs cyclic shift of the response signal after multiplication by the Walsh sequence in the opposite direction with respect to CS section 107 of mobile section 100 through the same length of time and outputs the result to in-phase adding section 207.

In-phase adding section 207 performs in-phase addition of the response signals after CS correction, each configured by the ZAC sequence of the same LB number, and outputs the response signal after in-phase addition to FFT 208. The in-phase addition processing will be described in detail later.

FFT (Fast Fourier Transform) 208 performs an FFT of the response signal after in-phase addition to extract the response signal mapped to a plurality of subcarriers, and outputs the mapped response signal to frequency equalizing section 215.

DFT matrix multiplying section 209 multiplies the reference signal by the complex conjugate of the DFT sequence multiplied in DFT matrix multiplying section 111 of mobile station 100, and outputs the result to CS correcting section 210.

CS correcting section 210 performs cyclic shift of the response signal after multiplication by the DFT matrix in the opposite direction with respect to CS section 112 of mobile station 100 through the same length of time, and outputs the result to in-phase adding section 211.

In-phase adding section 211 performs in-phase addition of the reference signals after CS correction, each of which is the ZAC sequence of the same LB number, and outputs the reference signal after in-phase addition to FFT section 212. The in-phase addition processing will be described in detail later.

FFT section 212 performs an FFT of the reference signal after in-phase addition to extract the reference signal mapped to a plurality of subcarriers, and outputs the mapped reference signal to correlation computing section 213.

Correlation computing section 213 performs correlation computation (complex division) of the ZAC sequence generated by the same method as in sequence number setting section 101 and ZAC sequence generating section 109 of mobile station 100 and the reference signal after the FFT, and outputs the correlation computation result to CH estimating section 214.

CH estimating section 214 performs channel estimation based on the correlation computation result, and outputs the channel estimation value to frequency equalizing section 215.

Frequency equalizing section 215 performs frequency equalization of the response signal after the FFT based on the channel estimation value and compensates for the phase fluctuation and the amplification fluctuation of the response signal.

Correlation computing section 216 performs correlation computation (complex division) of the ZAC sequence generated by the same method as in sequence number setting section 101 and ZAC sequence generating section 102 and the response signal after frequency equalization, and outputs the correlation computation result to judging section 217.

Judging section 217 judges whether the received response signal is ACK or NACK based on the quadrant of the correlation computation result.

Here, the same result can be obtained by providing CS correcting section 206 and CS correcting section 210 after FFT section 206 and FFT section 212 and performing phase rotation processing in the frequency domain.

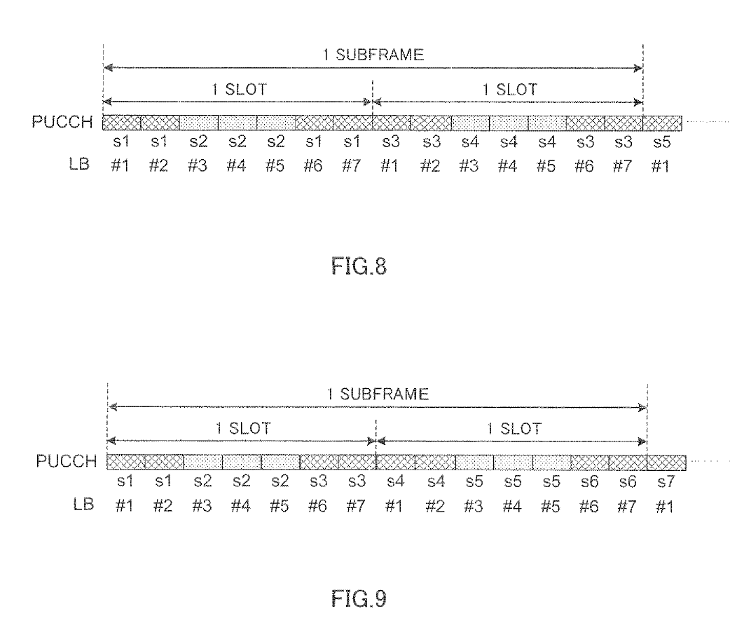

Next, the method of setting sequence numbers in mobile station 100 will be described in detail with reference to FIG. 8 and FIG. 9.

In FIG. 8 and FIG. 9, s1 to s5 and s1 to s7 show the sequence numbers of the ZAC sequence used for each symbol (each LB number). Response signals (ACK/NACK) are transmitted in LB numbers #1, #2, #6, and #7 and reference signals (RS) used to demodulate the response signals are transmitted in LB numbers #3, #4, and #5.

Sequence number setting section 101 changes the sequence number of the ZAC sequence at the transmission switching timing between the response signal and the reference signal (that is, in the boundary between the response signal and the reference signal). That is, in one slot, the sequence number of the ZAC sequence is changed in the boundary between the transmission timings of LB number #2 and LB number #3 and in the boundary between the transmission timings of LB number #5 and LB number #6.

Moreover, in FIG. 8, the sequence number of the ZAC sequence to spread the response signal transmitted immediately before the reference signal and the sequence number of the ZAC sequence to spread the response signal transmitted immediately after the reference signal are set the same. That is, the same ZAC sequence is set among LB numbers #1, #2, #6 and #7 for transmitting response signals. Then, the ZAC sequences differing from the ZAC sequences of LB numbers #1, #2, #6 and #7 are set to LB numbers #3, #4 and #5 for transmitting reference signals.

In addition, as shown in FIG. 9, the sequence number of the ZAC sequence to spread the response signal transmitted immediately before the reference signal and the sequence number of the ZAC sequence to spread the response signal transmitted immediately after the reference signal may be set different. That is, different ZAC sequences are set between LB numbers #1 and #2 for transmitting response signals and LB numbers #6 and #7 for transmitting response signals. Then, the ZAC sequences set to LB numbers #3, #4 and #5 for transmitting reference signals differ from the ZAC sequences set to LB numbers #1 and #2 and LB numbers #6 and #7.

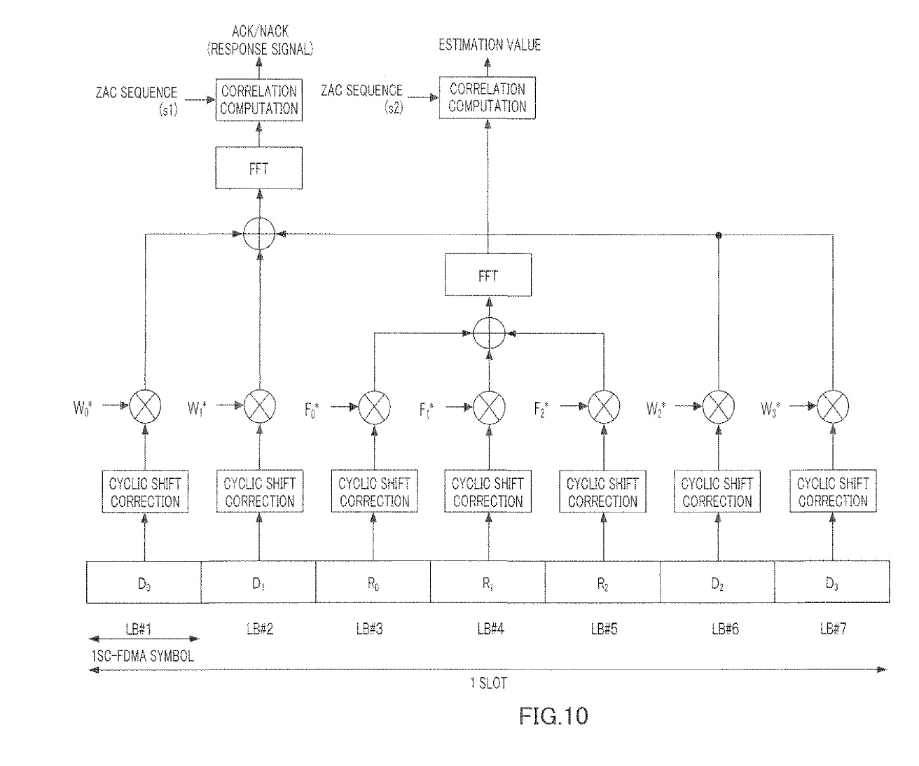

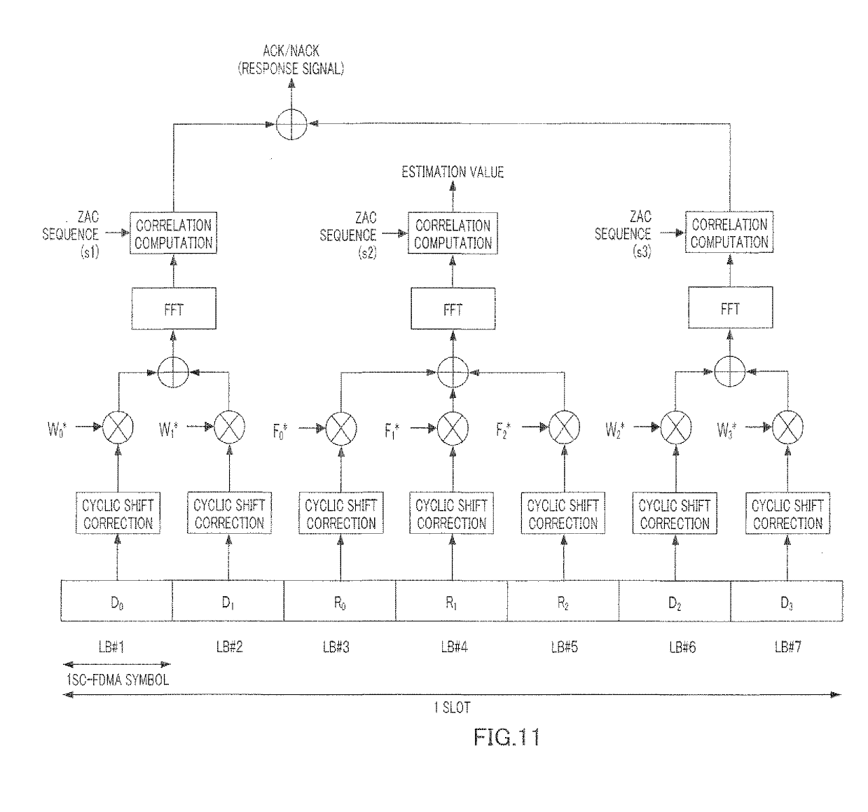

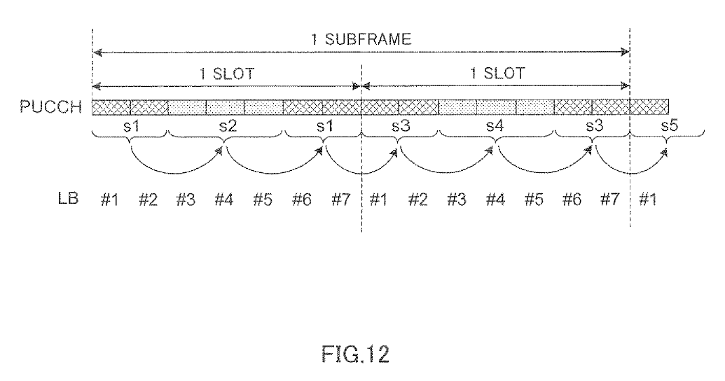

Next, the in-phase addition processing in base station 200 will be described in detail with reference to FIG. 10 and FIG. 11.

FIG. 10 shows in-phase conversion processing corresponding to the setting of sequence numbers shown in FIG. 8.

As shown in FIG. 8, when the sequence numbers are set, in-phase addition of the response signals of LB numbers #1, #2, #6 and #7 can be performed before an FFT, and the response signals can be demodulated by one FFT and one correlation computation. In addition, in-phase addition of the reference signals of LB numbers #3, #4 and #5 can be performed before an FFT, and the channel estimation value can be calculated by one FFT and one correlation computation.

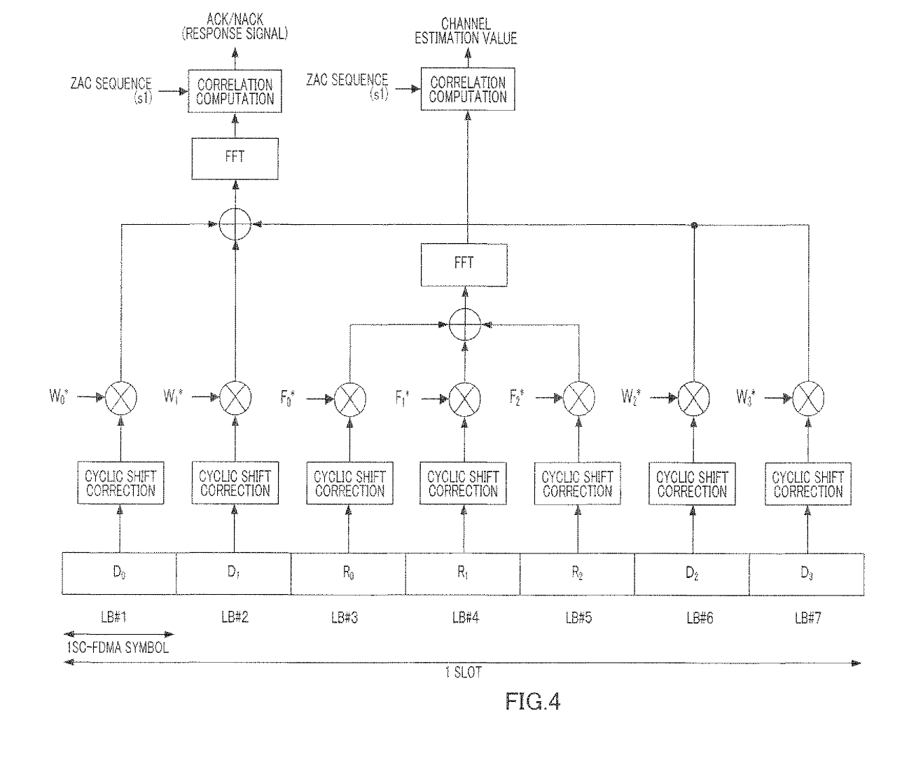

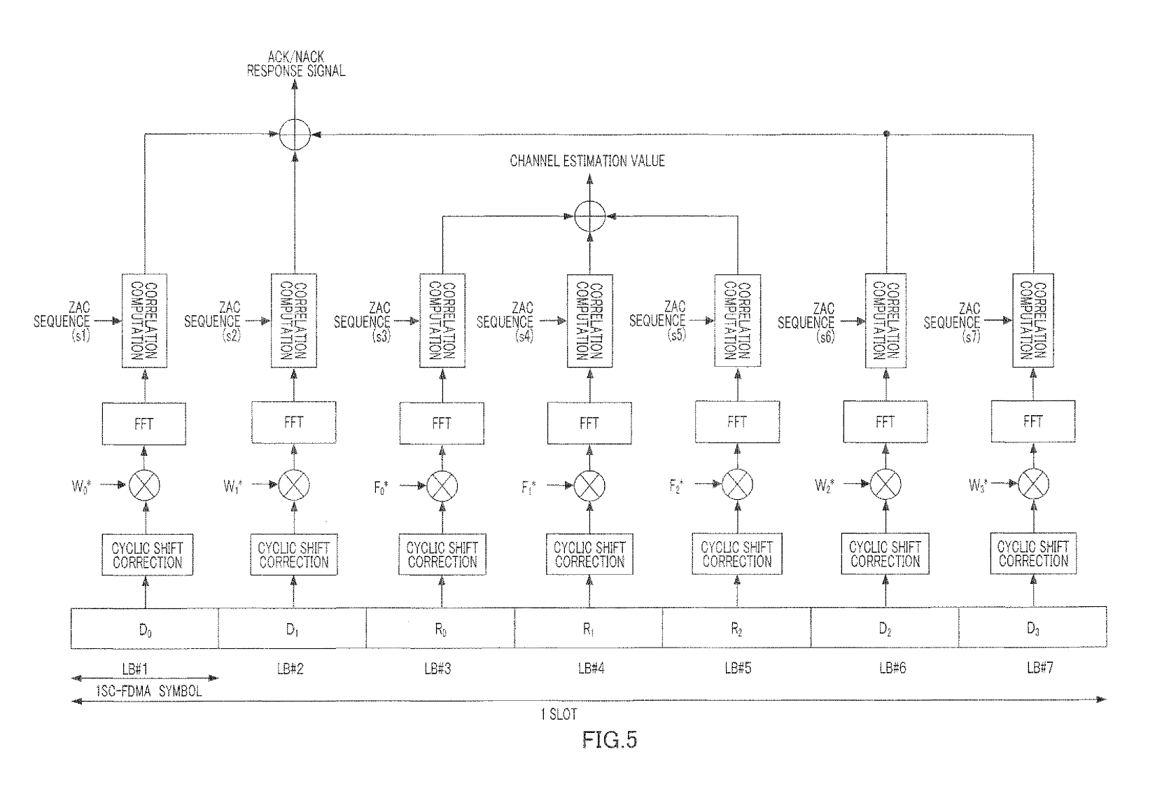

Therefore, the number of times of FFTs and ZAC sequence correlation computations in reception processing can be made the same as in the conventional sequence hopping at slot intervals shown in FIG. 4. In addition, in the present embodiment, since sequences are changed in each slot, it is possible to reduce the influence of inter-cell interference as compared with sequence hopping at slot intervals. That is, when the sequences in each slot are switched between the response signal and the reference signal twice as shown in FIG. 8, even if a collision of sequences occurs between adjacent cells, a collision between response signals or a collision between reference signals can be prevented, so that it is possible to further reduce the influence of inter-cell interference caused by collisions.

Moreover, FIG. 11 shows in-phase conversion processing corresponding to the setting of sequence numbers shown in FIG. 9. When sequence numbers are set as shown in FIG. 9, in-phase addition of the response signals of LB numbers #1 and #2 or LB numbers #6 and #7 can be performed before an FFT, and the response signals can be demodulated by performing FFTs twice and performing correlation computations twice. In addition, in-phase addition of the reference signals of LB numbers #3, #4 and #5 before an FFT, and the channel estimation value can be calculated by performing an FFT once and performing a correlation computation once.

Therefore, the number of times of FFTs and ZAC sequence correlation computations in reception processing can be made approximately the same as in the conventional sequence hopping at slot intervals shown in FIG. 4. In addition, since sequences are changed in each slot, it is possible to reduce the influence of inter-cell interference as compared with sequence hopping at slot intervals. That is, when the sequences are switched between the response signal and the reference signal three times in each slot as shown in FIG. 9, even if a collision of sequences occurs between adjacent cells, it is possible to prevent any two of a collision between LB numbers #1 and #2 in the first half of response signals, a collision between LB numbers #6 and #7 in the second half of response signals and a collision between reference signals, so that it is possible to further reduce the influence of inter-cell interference caused by collisions.

Here, the hopping pattern of sequence numbers may be defined by the sequence numbers used for continuous response signals or the sequence numbers used for continuous reference signals as shown in FIG. 12. For example, the sequence hopping pattern is defined as ‘<LB numbers #1 and #2>→<LB numbers #3, #4 and #5>→<LB numbers #6 and #7>→<LB numbers #1 and #2> . . . . ’ Moreover, the setting of sequence numbers shown in FIG. 8 can be performed by limiting the sequence hopping pattern such that the same sequence numbers are used between <LB numbers #1 and #2> and <LB numbers #6 and #7> as ‘s1→s2→s1→s3→s4→s3→ . . . ’.

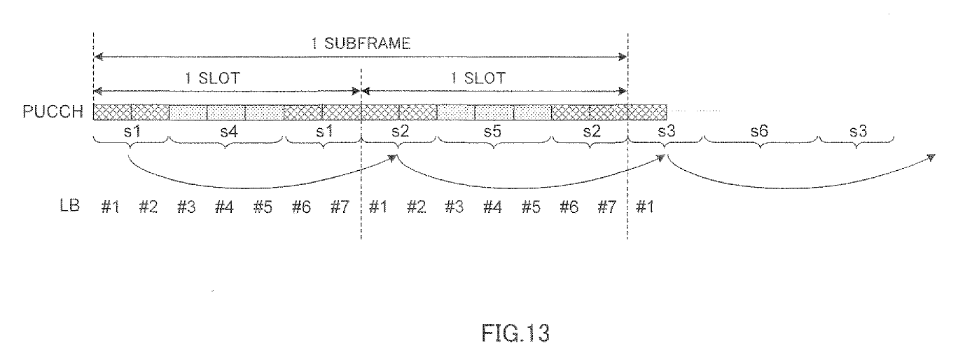

In addition, as shown in FIG. 13, the sequence hopping pattern may be defined individually for <LB numbers #1 and #2>, <LB numbers #3, #4 and #5> and <LB numbers #6 and #7>, respectively. For example, individual patterns that are changed at slot intervals can be set such that the sequence hopping pattern for <LB numbers #1 and #2> is ‘s1→s2→s3→ . . . ’, the sequence hopping pattern for <LB numbers #3, #4 and #5> is ‘s4→s5→s6→ . . . ’ and the sequence hopping pattern for <LB numbers #6 and #7> is ‘s1→s2→s3→ . . . ’ (the same as the sequence hopping pattern of <LB numbers #1 and #2>.

As described above, according to the present embodiment, although a common sequence is used within a response signal and a common sequence is used within a reference signal, sequences are changed in the boundary between transmitting timings of response signals and reference signals (i.e., transmission switching timings between response signals and reference signals), so that, it is possible to reduce the influence of inter-cell interference while maintaining the same amount of reception processing (amount of computation) as compared with sequence hopping at slot intervals.

Here, an example has been shown where a common sequence is used between LB numbers #1 and #2 and LB numbers #6 and #7 for transmitting response signals. However, the same effect as the above-described effect can be obtained by using a common sequence differing from sequences used within reference signals among a plurality of symbols within response signals. For example, the in-phase conversion processing shown in FIG. 11 can be also performed by using a common sequence among LB numbers #1 and #7 and LB numbers #2 and #6, and therefore an effect of randomizing interference can be obtained with the small amount of processing (amount of computation).

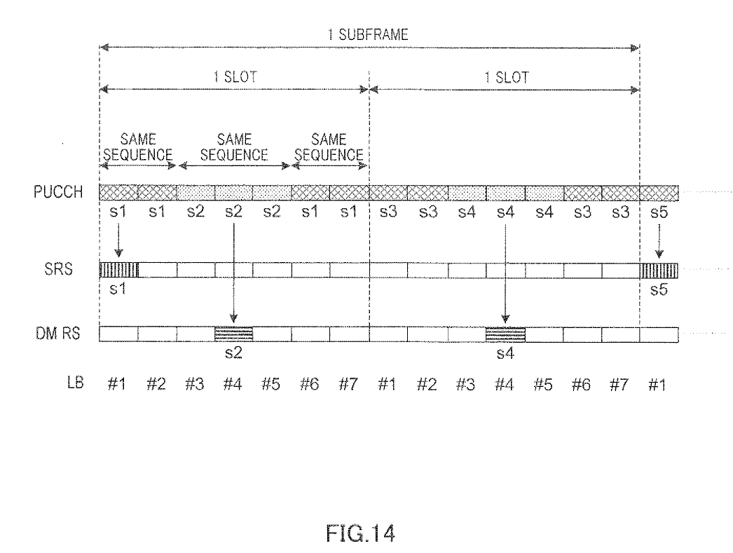

In addition, as shown in FIG. 14, the sequence hopping pattern of another channel (e.g., a DM-RS (Demodulation Reference Signal) or sounding RS of a PUSCH (Physical Uplink Scheduled Channel) may be calculated by switching the sequence numbers of a PUCCH (response signal and reference signal) (sequence hopping pattern). That is, the sequence number of the sequence used as a DM-RS and the sequence number of the sequence used as a sounding RS are the same sequence numbers used in a PUCCH. For example, when a DM-RS is transmitted in LB number #4, the sequence number used for LB number #4 of the PUCCH is used for the DM-RS. When a sounding RS is transmitted in LB number #1, the sequence number used for LB number #1 of PUCCH is used for the sounding RS. As described above, the sequence hopping pattern is common among a plurality of channels, so that it is possible to reduce the amount of signaling to report the sequence hopping pattern from the base station to the mobile station.

An embodiment of the present invention has been described so far.

Here, the sequence numbers used in the above description may be table numbers, index numbers or sequence group numbers when ZAC sequences are tabulated. In addition, as for a Zadoff-Chu sequence indicated by equation 1, u is referred to as a sequence number.

$${a}_{r} ( k ) = \{ \begin{matrix}{e}^{- j \frac{π u}{N} ( {k}^{2} )} , N \text{:} even \\ {e}^{- j \frac{π u}{N} ( k ( k + 1 ) )} , N \text{:} odd\end{matrix} \qquad ( Equation 1 )$$

Moreover, an example has been described above where the PUCCH is configured with seven symbols per slot (seven LBs). However, the present invention is not limited to this, for example, even if a PUCCH is configured such that one slot is composed of six symbols (four symbols for a response signal+two symbols for a reference signal), it is possible to obtain the same effect as the above-described effect by changing the sequence at the boundary between the transmission timings of response signals and reference signals.

In addition, the PUCCH used in the above description is a channel for feedback of ACK or N ACK and therefore may be referred to as an ACK/NACK channel.

Moreover, when control information (e.g., scheduling request information or channel quality information (CQI)) other than the response signal is fed back, the present invention is applicable as with the above description.

Moreover, the mobile station may be referred to as a terminal station, a UE, an MT, an MS and an STA (Station). Furthermore, a base station may be referred to as a Node B, a BS and a AP. Furthermore, a subcarrier may be referred to as a tone. Furthermore, a CP may be referred to as a guard interval (GI).

Furthermore, the method of transforming between the frequency domain and the time domain is not limited to the IFFT and the FFT.

Furthermore, in the above-described embodiment, a case where the present invention is applied to the mobile station has been described. However, the present invention is applicable to a radio communication terminal fixed and in resting state or a radio communication relay station apparatus, which operates the same as the mobile station between the base station and the radio communication apparatus. That is, the present invention is applicable to all ratio communication apparatuses.

Moreover, although cases have been described with the embodiments above where the present invention is configured by hardware, the present invention may be implemented by software.

Each function block employed in the description of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2007-282450, filed on Oct. 30, 2007, including the specification, drawings and abstract, is incorporated herein by reference in its entirety.

### INDUSTRIAL APPLICABILITY

The present invention is applicable to a mobile communication system and so forth.

1. A radio communication apparatus comprising:
a spreading section that spreads a response signal using a first sequence;
a generating section that generates a reference signal for demodulating the response signal using a second sequence; and
a sequence setting section that switches between the first sequence and the second sequence at a timing to switch between transmission of the response signal and transmission of the reference signal.

2. A radio communication apparatus according to claim 1 wherein:
the sequence setting section sets the first sequence for the response signal transmitted immediately before the reference signal and the first sequence for the response signal transmitted immediately after the reference signal to the same sequences.

3. A radio communication apparatus according to claim 1, wherein the sequence setting section sets the first sequence for the response signal transmitted immediately before the reference signal and the first sequence for the response signal transmitted immediately after the reference signal to different sequences.

4. A sequence control method comprising the steps of:
spreading a response signal using a first sequence;
generating a reference signal for demodulating the response signal using a second sequence; and
switching between the first sequence and the second sequence at a timing to switch between transmission of the response signal and transmission of the reference signal.
